(19) United States
(12) Patent Application Publication
(10) Pub. No.: US 2016/0283981 A1
(43) Pub. Date: Sep. 29, 2016

(54) Flash Sale System, Process, and Program

(71) Applicants: Jared R. Sperli, Menlo Park, CA (US); Ryan T. Hardy, Fort Mill, SC (US); Craig E. Bohn, San Jose, CA (US)

(72) Inventors: Jared R. Sperli, Menlo Park, CA (US); Ryan T. Hardy, Fort Mill, SC (US); Craig E. Bohn, San Jose, CA (US)

(21) Appl. No.: 15/083,256

(22) Filed: Mar. 28, 2016

Related U.S. Application Data
(60) Provisional application No. 62/139,632, filed on Mar. 27, 2015.

(51) Int. Cl. G06Q 30/02; H04W 4/12; G06Q 10/08

(52) U.S. Cl. CPC G06Q 30/0261; G06Q 10/083; G06Q 30/0272; G06Q 30/0267; H04W 4/12

(57) ABSTRACT

An integrated sales and logistics system for tracking existing and ongoing sales, to develop supplemental sales offers marketed directly to likely supplemental customers located near or along the delivery route to and from a pending customer, along with an assortment of related and tangential tasks and processes that help to optimize the production and logistics capacity of the goods supplier, including the system and process for determining the likelihood of multiple potential customers to create and contact a list of likely supplemental customers.

### CROSS-REFERENCE TO RELATED APPLICATIONS

This application claims the benefit of U.S. Provisional Application Ser. No. 62/139,632, filed on Mar. 27, 2017, by the present inventors, entitled “Flash Sale System, Process, and Program,” which is hereby incorporated by reference in its entirety for all allowable purposes, including the incorporation and preservation of any and all rights to patentable subject matter of the inventor, such as features, elements, processes and process steps, and improvements that may supplement or relate to the subject matter described herein.

### STATEMENT REGARDING FEDERALLY SPONSORED RESEARCH OR DEVELOPMENT

Not Applicable

### BACKGROUND OF THE INVENTION

This invention relates generally to the sale of goods, and more specifically to a system for selling goods that directly integrates the ordering process and delivery logistics system to a supplemental direct marketing system and process. Current sales processes work on the principle of promptly and efficiently responding to orders for goods received from customers. It would be an improvement to the field of art to have a sales system that monitors the ongoing and existing sales, and develops supplemental sales offers marketed directly to likely customers located near the pending customers or along the delivery route to and from such pending customers. It would be an additional improvement to establish, maintain, and access potential customer profiles in order to customize sales offers to customer as determined by their likelihood to buy at the particular moment under certain conditions, given their buying habits, in order to optimize production and logistical capacity and efficiency.

### SUMMARY OF THE INVENTION

The current development is an integrated sales and logistics system that tracks existing and ongoing sales, and develops supplemental sales offers marketed directly to likely supplemental customers located near or along the delivery route to and from a pending customer, along with an assortment of related and tangential tasks and processes that help to optimize the production and logistics capacity of the goods supplier. Using past or likely customer data, inventory and production capabilities, and geolocation and delivery route data of delivery assets, the system can present unallocated inventory for sale to likely customers under suitable terms through instant ad delivery, where customized offers are sent to the likely customers, and logistic resources are notified of new deliveries in a timely manner.

### BRIEF DESCRIPTION OF THE DRAWINGS

FIG. 1 is a block diagram of an exemplary Flash Sale System and Program according to the present invention;

FIG. 2 is a flowchart illustrating an exemplary process for establishing profiles within the Subscriber Enrollment Module of FIG. 1;

FIG. 3 is a flowchart illustrating an exemplary process within the Subscriber Administration Module of FIG. 1;

FIG. 4 is a flowchart illustrating an exemplary process within an exemplary Flash Sale System and Program according to the present invention;

FIG. 5 is a flowchart illustrating exemplary sub-processes within the exemplary routine of Receiving Order of the process in FIGS. 4;

FIG. 6 is a flowchart illustrating exemplary sub-processes within the exemplary routine of Identifying Potential Supplemental Customers of the process in FIG. 4;

FIG. 7 is a flowchart illustrating exemplary sub-processes within the exemplary routine of Calculating Optimal Sale Offer to Meet Capacity of the process in FIG. 4;

FIG. 8 is a flowchart illustrating an exemplary Flash Sale Cycle process within an exemplary Flash Sale System and Program according to the present invention; and

FIG. 9 is a flowchart illustrating exemplary sub-processes within the exemplary routine of Verifying Customer Offer Acceptance of the process in FIG. 8.

### DESCRIPTION OF THE PREFERRED EMBODIMENT

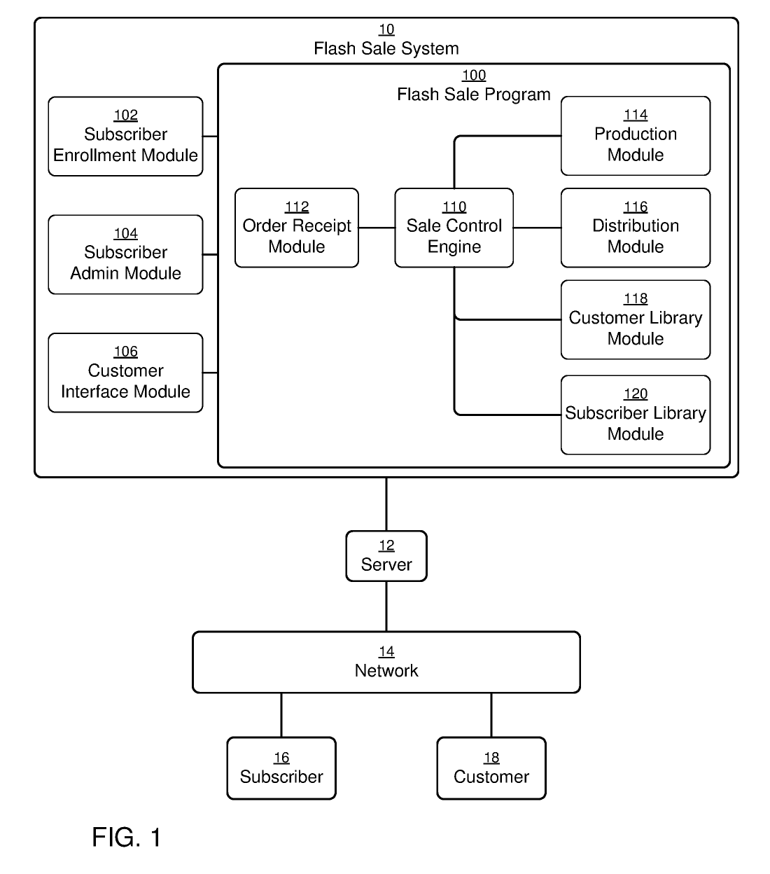

An exemplary flash sale system 10, process, and program will now be described in detail with reference to FIG. 1 through FIG. 3 of the accompanying drawings. The embodiment of flash sale system 10 (hereinafter “FS system 10”) is shown in FIG. 1, which include a flash sale program 100, connected to a network 14 via a server 12. An appropriate network 14 may include the Internet and the World Wide Web. A suitable server 12 may include a variety of devices that link a suitable computer system capable of running the exemplary flash sale program to the particular network 14. The network 14 provides connectivity to both a subscriber 16 the flash sale program 100 and a customer 18, which are representative of the individual and plurality of subscribers 16 and customers 18 desiring connection. It is also understood that various mobile communication technologies, by a myriad of names, including smartphone, cellphone and mobile service networks, as well as any other system that permits suitable communication with the FS program 100, may also be used in the role as the server 12 and network 14.

The exemplary FS system 10 includes an exemplary flash sale program 100 (hereinafter “FS program 100”), which is a software process system in digital command form that is executable on a computer. The FS system 10 comprises modules and engines, and sub-modules and sub-engines, which, both individually and in combination, perform particular processes and tasks, and exchange the results in the form of modified data instructions and files, therebetween. The FS program 100 may be directly accessed and engaged by a subscriber enrollment module 102, a subscriber administrative module 104, and a customer interface module 106. The exemplary subscriber enrollment module 102 may provide an interface for subscribers 16 to initially engage the FS program 100 and submit data to establish a collection of subscriber 16 profiles within the exemplary subscriber library module 120 of the exemplary FS system 10. The exemplary subscriber administrative module 104 may provide an interface for subscribers 16 to engage the FS program 100 on an ongoing basis, and adjust data to update, supplement, and correct their subscriber 16 profile within the subscriber library module 120 of the exemplary FS system 10. The exemplary customer interface module 106 may provide an interface for customers 18 to engage the FS program 100 through data transfer to do a myriad of tasks, including, but not limited to ordering goods, verifying offers, monitoring pending orders, receiving offers, and providing and correcting personal and profile information within the FS system 10. The customer interface module 106 may be reached by the customer 18 through the server 12 from the network 14. Social media platforms, such as Twitter®, Snapchat®, and Facebook®, may be included as part of the server 12 and network 14 used to contact customer 18.

The exemplary FS program 100 includes a sale control engine 110, an order receipt module 112, a production module 114, a distribution module 116, a customer library module 118, and a subscriber library module 120. The exemplary order receipt module 112 compiles, organizes and manages various forms of data input mediums that may include a terminal for a phone-answer resource, direct link from a text server, or other general server 12 and network 14 connection to a customer 18, among others, to document orders from customer 18. The exemplary production module 114 compiles and manages data that may directly correlate to the physical production of the good, to include inventory and production capacities, flow sequence, processing time, materials, personnel, equipment availability, and production and logistical capacity goals, among other things that may impact the production of the good. The exemplary distribution module 116 compiles and manages data that may directly correlate to the physical distribution and logistics system for delivery of the good, which may include inventory and production capacities, flow sequence, processing time, geolocation information of the service area, including potential customer addresses, and materials, personnel, equipment location and availability, and traffic patterns, among other things that may impact the distribution of the good.

The exemplary customer library module 118 compiles and manages data that may directly correlate to the customer 18, to include both past and potential customers 18, and which may include geolocation information of the service area, potential customer addresses, order history, prices paid, payment form information, types of goods purchased, quantities purchased, the preferred means of contact and parameters under which each means is most suitable, and data related to timing and trends of purchases, among other data. Such other data may include a score correlated to the likelihood a particular customer 18 will purchase under particular terms, or the underlying data needed to develop other such purchase anticipation projections and probabilities. Such other data may also include a point scale or credit that the customer has earned for activity, which may include past orders, past supplemental sale purchase, and initiating or participating in sales that previously created favorable supplemental sales. The exemplary subscriber library module 120 compiles and manages data that may directly correlate to the subscriber 16, to include account, menu, inventory, and delivery, delivery asset and location data information data, as well as existing and prospective customer information data, and ad parameters data, among other data related to the subscriber 16.

The exemplary sale control engine 110 coordinates and controls the flow of data between the order receipt module 112, the production module 114, the distribution module 116, the customer library module 118, and subscriber library module 120. Additionally, the sale control engine 110 may calculate representative scores that can be assigned to particular customers 18, or particular customer buying patterns, that may be useful in determining anticipated sales activity. Additionally, the sale control engine 110 may control communication with a customer 18, through the customer interface module 106. Additionally, the sale control engine 110 may use data from one or more of the order receipt module 112, the production module 114, the distribution module 116, the customer library module 118, and subscriber library module 120 to develop models of predictably likely supplemental orders. The data coordinated, calculated, and controlled by the exemplary sale control engine 110 may include all the data flowing to and from the FS system 10 modules and sub-modules. An example of data flowing between the FS system 10 modules and sub-modules may include the sale control engine 110 instructing the production module 114 to make additional goods to support predictably likely supplemental orders. An additional example of data flowing between the FS system 10 modules and sub-modules may include the sale control engine 110 instructing the distribution module to adjust a delivery route in anticipation of predictably likely supplemental orders, along with the additional good for the likely supplemental orders.

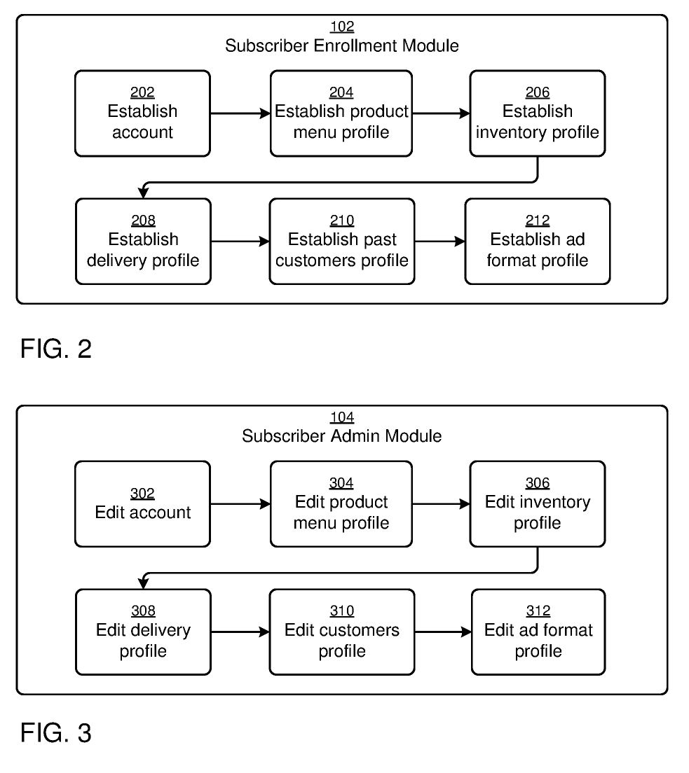

Referring now primarily to FIG. 2, exemplary process steps are shown that may be enabled by the subscriber enrollment module 102. To permit a subscriber 16 to use the exemplary FS system 10, a subscriber may access the FS system 10 through a network 14, via a server 12, to effect establishing an account 202, wherein the subscriber 16 may provide key data important in supporting the relationship between the customer and the entity managing the FS system 10, which, in the exemplary embodiment, may include identification, payment and location information. In the exemplary embodiment, the subscriber may also establish a product menu profile 204, which may include data regarding, among other things, various product offerings, hours of availability, and list pricing and terms. In the exemplary embodiment, the subscriber may also establish an inventory profile 206, which may include data regarding, among other things, quantities, estimated availability, and related and alternative goods. In the exemplary embodiment, the subscriber may also establish a delivery profile 208, which may include data regarding, among other things, the location of goods, location of delivery assets, mapping resources to plan, manage and adjust delivery routes, estimated delivery times, anticipated delivery means and limitations, and other logistical concerns and limitations. In the exemplary embodiment, the subscriber may also establish a past customers profile 210, which may include data regarding, among other things, the location of goods. And, in the exemplary embodiment, the subscriber may also establish an ad format profile 212, which may include data regarding, among other things, samples of trademarks, trade dress guidance, sample ad texts, and any other style, format, layout or wording guidance and limitations for use by the FS system 10 in the creation of ads for direction to customers 18.

Referring now primarily FIG. 3, exemplary process steps are shown that may be enabled by the subscriber administration module 104. To permit a subscriber 16 to use the exemplary FS system 10, a subscriber may access the FS system 10 through a network 14, via a server 12, to effect editing of an account 302, wherein the subscriber 16 may edit key data important in supporting the relationship between the customer and the entity managing the FS system 10, which, in the exemplary embodiment, may include identification, payment and location information. In the exemplary embodiment, the subscriber may also edit a product menu profile 304, which may include data regarding, among other things, various product offerings, hours of availability, and list pricing and terms. In the exemplary embodiment, the subscriber may also edit an inventory profile 306, which may include data regarding, among other things, quantities, estimated availability, and related and alternative goods. In the exemplary embodiment, the subscriber may also edit a delivery profile 308, which may include data regarding, among other things, the location of goods, location of delivery assets, mapping resources to plan, manage and adjust delivery routes, estimated delivery times, anticipated delivery means and limitations, and other logistical concerns and limitations. In the exemplary embodiment, the subscriber may also edit a past customers profile 210, which may include data regarding, among other things, the location of goods. And, in the exemplary embodiment, the subscriber may also edit an ad format profile 212, which may include data regarding, among other things, samples of trademarks, trade dress guidance, sample ad texts, and any other style, format, layout or wording guidance and limitations for use by the FS system 10 in the creation of ads for direction to customers 18.

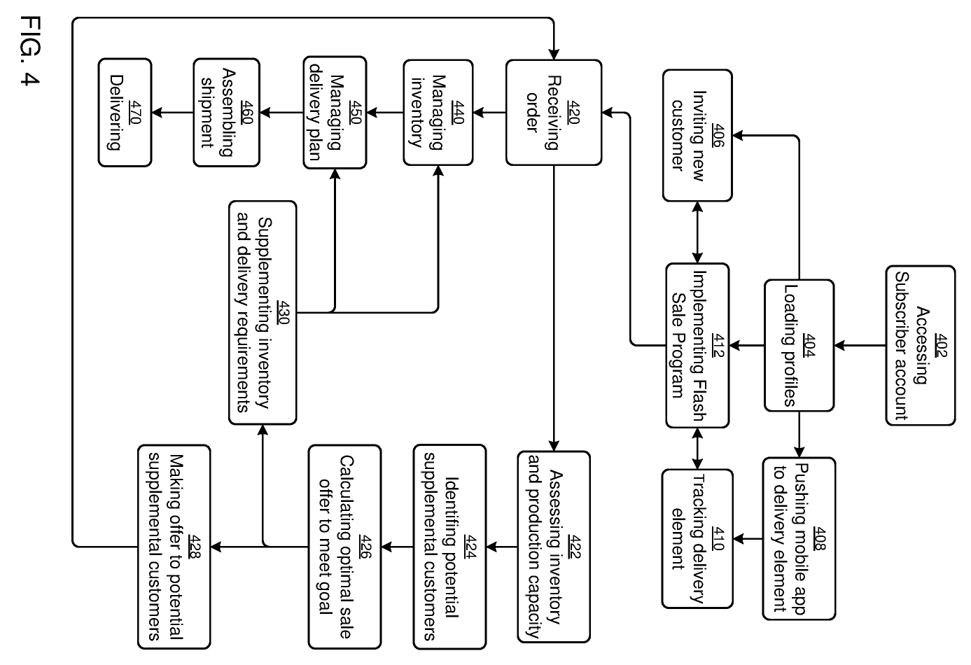

Focusing now on FIG. 4, an exemplary process for the implementation of the exemplary FS system 10 is shown. An exemplary process for the implementation of the exemplary FS system 10 includes the subscriber 16 accessing the subscriber account 402. Such access can be accomplished through the network 14 and server 12 to either the subscriber enrollment module 102 or the subscriber administrative module 104, depending on whether the subscriber 16 has previously established the various profiles. Once having access to the FS system 10, the subscriber 16 may load or edit data related to the various profiles 404. The exemplary customer interface module 106 may affect inviting new customers 406. The format of the invitation to new customers 18 may be governed by the particular subscriber's ad format profile. The exemplary sale control engine 110 controls, coordinates, makes calculations, creates priorities, and integrates the operation of the customer interface module 106, the subscriber library module 120, and the customer library module 118, and potentially other modules.

Once delivery assets are defined, such as in a delivery profile, the FS system 10 may initiate pushing the mobile application of the FS program 100 to various delivery elements 408. The FS system 10, potentially through the installed application of the FS program 100 may facilitate the tracking of the various delivery elements 410.

With the appropriate modules of the FS system 10 enabled, the FS system 10 may implement the FS program 100, triggering the sale control engine 110 to initiate the control and correlation of the FS program's 100 modules. In an example, the process of optimizing the production and delivery capacities of a subscriber may be seen from the perspective of initially receiving an order 420, though the FS system 10 may operate in an ongoing mode, with no specific starting point. An order is received in the order receipt module 112, which interacts with the sale control engine 110. In the normal course of fulfilling the sale, the FS system 10 executes instructions to manage the inventory of goods 440, manage the delivery plan 450, assemble the shipment of goods for delivery 460, and to execute the delivery 470. The FS program 100 is intended to work continually, monitoring and re-calculating the production and logistics situations, and operating the respective modules and sub-modules to attain specified goals and objectives.

With the implementation of the FS program 100, upon receiving an order 420 the sale control engine 110 interacts with one or more of the production module 114, distribution module 116, customer library module 118 and the subscriber library module 120, and assesses inventory and production capacity 422. The sale control engine 110 may also use customer information from the customer interface module, including the order information to determine customer location. The sale control engine 110 may also use distribution asset locations from the distribution module 116 to determine the location of delivery assets, and optional routes to obtain inventory and make deliveries, as well as potential supplemental deliveries. The exemplary sale control engine 110 may identify potential supplemental customers 424. The location of potential supplemental deliveries may be a factor in identifying potential supplemental customers 424, among other supply and logistics considerations, based on information from data from one or a combination of the production module 114, distribution module 116 and customer library module 118. The sale control engine 110 may use information data created in the assessment of inventory and production capacity and the identified potential customers, along with data from the production module 114, distribution module 116, customer library module 118, and the subscriber library module 120 in developing optimal sale offer to meet production and logistical goals 426.

Once the sale control engine 110 develops the combination of the optimal sale offer for each of the identified potential supplemental customers the customer interface module 106 delivers to the potential supplemental customer the particular offer for that customer by the most suitable means under the conditions, as documented in the customer library module 118. Additionally, the sale control engine 110 supplements inventory and delivery requirements in anticipation of the predictably likely supplemental orders, which impact the processes of managing the inventory 440 and managing the delivery plan 450, so that the assembled shipment 460 and delivery 470 include the reasonably anticipatable supplementally sold goods from the offers made to the potential supplemental customers 428. The offers may be communicated to the potential supplemental customers in an assortment of suitable ways, including mail, electronic mail, phone call, and text message, including Short Message Service (“SMS”) and multimedia messages (“MMS”), to name a couple examples.

The offers extended to the potential supplemental customer 428 are then available for acceptance by the potential supplemental customer. Upon action by the potential customer to accept the offer, the FS system 10 receives an order 420.

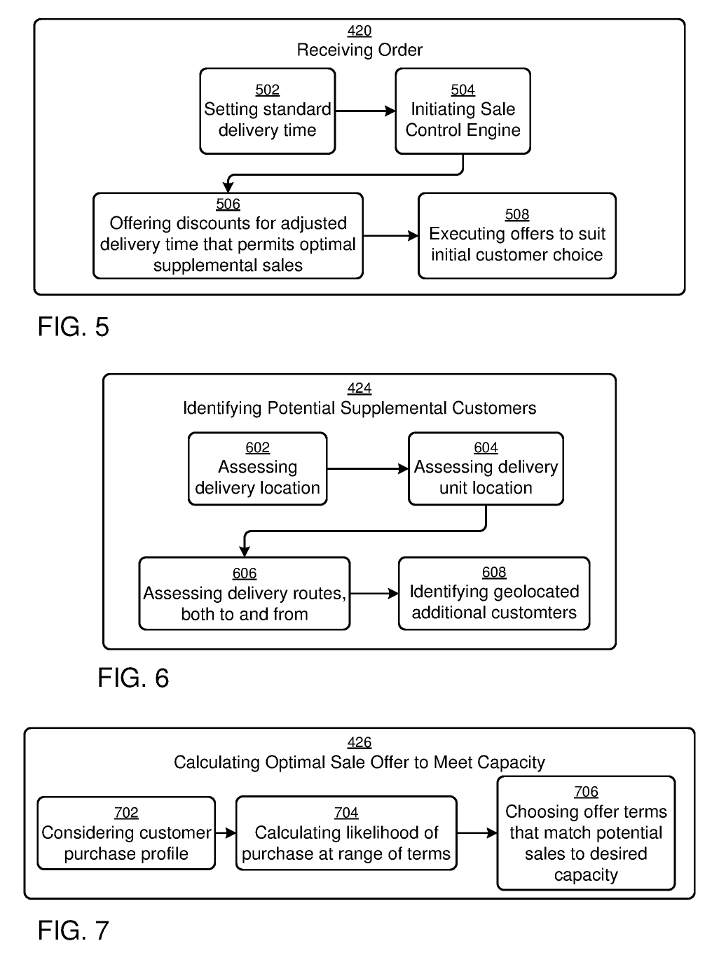

Referring now primarily to FIG. 5, the process of receiving an order 420 may also include setting a standard delivery time 502, initiating the sales control engine 504, offering discounts for adjusted delivery time that permits optimal supplemental sales 506, and executing offers to suit initial customer choices with regard to acceptable delivery options 508.

Referring now primarily to FIG. 6, the process of identifying potential supplemental customers 424 may also include assessing the delivery location 602, assessing delivery asset location 604, assessing delivery routes, both to and from the customer 606, and identifying geolocated additional customers for supplemental sales 608.

Referring now primarily to FIG. 7, the process of calculating an optimal sale offer to meet goals 426 may also include considering customer purchase profiles 702, calculating likelihood of purchase at a range of sales terms and conditions 704, and choosing offer terms that match potential sales to desired capacity goals 706 for the particular targeted supplemental customers reasonably, anticipatably assured to meet the set goals, such as for production and logistical objectives.

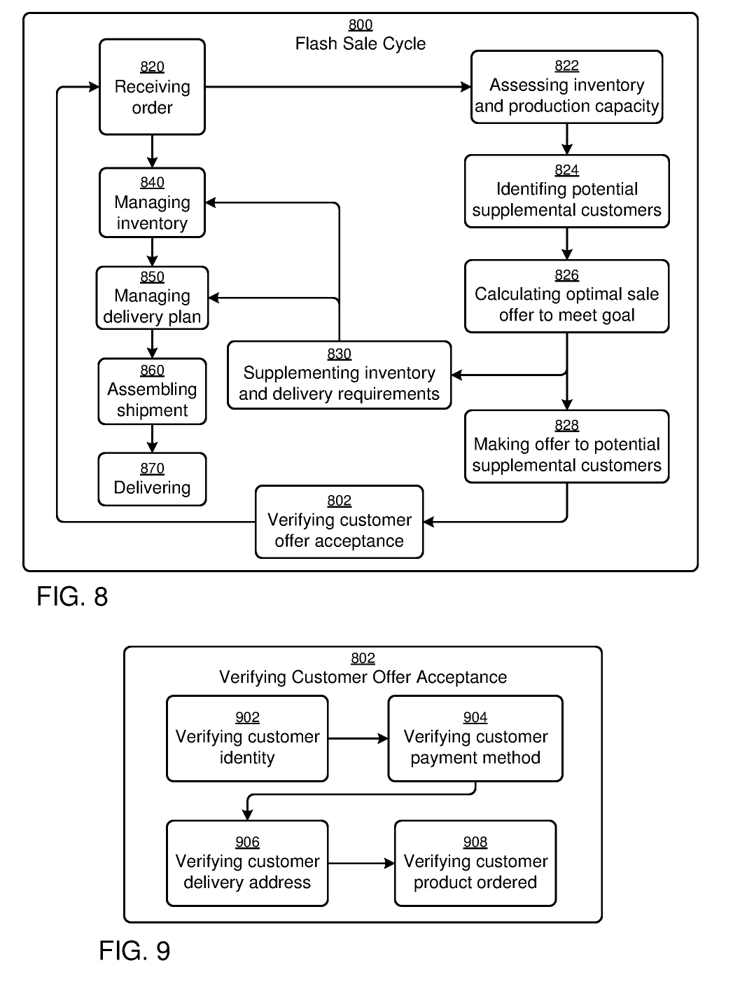

Focusing now on FIG. 8, an exemplary process for the implementation of the exemplary FS system 10 in a flash sale cycle process 800 is shown. With the appropriate modules of the FS system 10 enabled, the flash sale program 110 may implement the flash sale cycle process 800, where the sale control engine 110 may initiate the control and correlation of the FS program's 100 modules. In an example, the process of optimizing the production and delivery capacities of a subscriber with the flash sale cycle process 800 may be seen from the perspective of initially receiving an order 820, though the FS system 10 may operate in an ongoing mode, with no specific starting point. An order may be received in the order receipt module 112, which interacts with the sale control engine 110. In the normal course of fulfilling the sale, the FS system 10 executes instructions to manage the inventory of goods 840, manage the delivery plan 850, assemble the shipment of goods for delivery 860, and to execute the delivery 870. The FS program 100 may work continually, monitoring and re-calculating the production and logistics situations, and operating the respective modules and sub-modules to attain specified goals and objectives.

With the implementation of the FS program 100, upon receiving an order 820 the sale control engine 110 may interacts with one or more of the production module 114, distribution module 116, customer library module 118 and the subscriber library module 120, and assesses inventory and production capacity 822. The sale control engine 110 may also use customer information from the customer interface module, including the order information to determine customer location. The sale control engine 110 may also use distribution asset locations from the distribution module 116 to determine the location of delivery assets, and optional routes to obtain inventory and make deliveries, as well as potential supplemental deliveries. The exemplary sale control engine 110 may identify potential supplemental customers 824. The location of potential supplemental deliveries may be a factor in identifying potential supplemental customers 824, among other supply and logistics considerations, based on information from data from one or a combination of the production module 114, distribution module 116 and customer library module 118. The sale control engine 110 may use information data created in the assessment of inventory and production capacity and the identified potential customers, along with data from the production module 114, distribution module 116, customer library module 118, and the subscriber library module 120 in developing optimal sale offer to meet set goals 826, such as for production and logistical objectives.

Once the sale control engine 110 develops the combination of the optimal sale offer for each of the identified potential supplemental customers the customer interface module 106 may deliver to the potential supplemental customer the particular offer for that customer by the most suitable means under the conditions, as recorded in the customer library module 118. Additionally, the sale control engine 110 may supplement inventory and delivery requirements in anticipation of the predictably likely supplemental orders, which may impact the processes of managing the inventory 840 and managing the delivery plan 850, so that the assembled shipment 860 and delivery 870 include the reasonably anticipatable supplementally sold goods from the offers made to the potential supplemental customers 828. The offers may be communicated to the potential supplemental customers in an assortment of ways, including mail, electronic mail, phone call, and text message, including short message service (“SMS”) and multimedia messages (“MMS”), to name a couple examples.

In an exemplary embodiment, the flash sale cycle process 800 may be applied to a variety of goods and services, including food, construction supplies, office supplies, and other types of goods and services suitable for commercial delivery. In a food example, an initial order may initiate the flash sale process 800, though other actions and motivations, such as the need for orders, may initiate the flash sale process 800. An order received 820 may include an ordered product and a delivery location. Assessing the inventory and production capacity 822 may include seeing how many food items are currently being prepared for delivery, or being delivered with the production module 114 and distribution module 116. Identifying potential supplemental customers 824 may include locating the geographical location of the delivery, as well as the delivery route both to and from the delivery location, and identifying potential customers located geographically near that location and along that route, with the customer library module 118. Customers may be enabled to inform the system of their current location for a period of time, or establish rules for what their location will be according to such parameters as date and time. Targeted sale offers may then be created to appeal to the particular potential customers, using their customer profile, maintained in the customer library module 118, and designed to achieve the food production company's sales desires, thereby calculating optimal sale offers to meet goals 826.

The supplemental sales, or flash sale cycle process 800, may then progress to making the offer to the potential customers 828. This may be done by a variety of means, and may include the sale offer, and limitations, such as duration and quantity available. The potential customer may accept the offer under pre-established parameters recorded in their customer account, held in the customer library module 118, by responding to the message. In the case of text message distribution, accepting the offer may include responding to the text message with an affirming message, which may include “yes,” “y,” a smiley-face, and other clear indicators of acceptance.

Alternatively, the message may include the sale offer and a link to a Uniform Resource Locator (“URL”) or web address. Such link may be embedded in part of the message. Such a link may permit the potential customer to accept the sale offer while making changed to the customer's established payment method 904, delivery address 906, and product order 908. Additionally, such link may permit the subscribing food product provider (“subscriber”) to allow verification of the potential customer's identify 902. The customer may accept the offer and verify their offer acceptance 802 through the URL or web address, creating an order in the order receipt module 112.

Referring now also to FIG. 9, the offers extended to the potential supplemental customer 828 may then be available for acceptance by the potential supplemental customers. Upon action by the potential customer to accept the offer, which may result in the FS system 10 receiving an order 820, verifying of the customer acceptance 802 may be desired. Verification may be done in an assortment of ways, including phone call, email, and text messaging. An appropriate verification may seek to verify information related to the customer order, including the customer's identity 902, payment method 904, delivery address 906, and product ordered 908.

Focusing now primarily on FIGS. 1, 8 and 9, in an exemplary embodiment, the flash sale cycle process 800 may be applied to a variety of goods and services, including food, construction supplies, office supplies, and other types of goods and services suitable for commercial delivery. In a food example, an initial order may initiate the flash sale process 800 may initiate the flash sale process 800. Other actions and motivations, such as the subscriber's need or desire for orders, may also initiate the flash sale process 800. An order received 820 may include an ordered product, the identity of a customer, and a delivery location. Assessing the inventory and production capacity 822 may include seeing how many food items are currently being prepared for delivery, or being delivered with the production module 114 and distribution module 116. Identifying potential supplemental customers 824 may include locating the geographical location of the delivery, as well as the delivery route both to and from the delivery location, and identifying potential customers located geographically near that location and along that route, with the customer library module 118. Customers may be enabled to inform the system of their current location for a period of time, or establish rules for what their location will be according to such parameters as date and time. A customer may establish set alternate delivery locations and payment methods, which would permit the customer to indicate a particular choice at the time of acceptance of a future order. Targeted sale offers may then be created to appeal to the particular potential customers, using their customer profile, maintained in the customer library module 118, and designed to achieve the food production company's sales desires, thereby calculating optimal sale offers to meet goals 826. Current customers may be included in the potential customers, and may be targeted for suggestive sales of additional goods to add to their existing order.

The supplemental sales, or flash sale cycle process 800, may then progress to making the offer to the potential customers 828. This may be done by a variety of means and may include the sale offer, and limitations, such as duration and quantity available. The potential customer may accept the offer under pre-established parameters recorded in their customer account, held in the customer library module 118, by responding to the message. In the case where the offer is communicated by a text message, the potential customer may accept the order my responding to the text message with an indication of acceptance. The response may be established be the subscriber and customer as sufficient to indicate acceptance. Alternatively, the message may include the sale offer and it may, in the form of an email or text, include a link to a Uniform Resource Locator (“URL”) or web address. Such a link may permit the potential customer to accept the sale offer while making changed to the customer's established payment method 904, delivery address 906, and product order 908, and it may permit the subscribing food product provider to allow verification of the potential customer's identify 902. The customer may accept the offer and verify their offer acceptance 802 through the URL or web address, creating an order in the order receipt module 112.

In an alternate example, the flash sale system 10 and flash sale cycle process 800 may be applied to construction supplies. In such a situation, workers may arrive at their worksites at the start of a shift and assess their requirements for supplies. Upon noting needs they may contact the supplier and place an order. The supplier may then use the flash sales cycle 800 to identify other contractors in the area or along the route of the initial order, and develop and communicate specific flash sale offers to those other contractors. By notifying similarly located customers, contractors in this example, the supplier may be able to provide the supplies more efficiently, and therefore at a lower cost, and pass some of the savings along to their customers.

A FS system 10 subscriber may provide a supplemental benefit to a customer who initiate orders that trigger productive flash sales cycles 800, which in turn may encourage such customers to be the first customer to order in the future. Alternatively, the FS system 10 subscriber may choose to give other benefits to a customer who frequently participate in flash sales, in order to encourage and reward their continued participation and patronage.

The examples contained in this specification are merely possible implementations of the current system, and alternatives to the particular steps, including the scope and sequence, may still fall within the scope of allowed claims. The foregoing disclosure and description of the invention is illustrative and explanatory thereof. The examples contained in this specification are merely possible implementations of the current system, and alternatives to the particular features, elements and process steps, including scope and sequence of the steps may be changed without departing from the spirit of the invention. The present invention should only be limited by the examined and allowed claims, and their legal equivalents, since the provided exemplary embodiments are only examples of how the invention may be employed, and are not exhaustive.

Example claims that may ultimately allowed may include claims to a sale system for generating the supplemental sale of goods that comprises a sale control engine, an order receipt module, a production module, a distribution module, a customer library module, and a subscriber library module, and the sale control engine coordinating the function and interaction of the order receipt module, the production module, the distribution module, the customer library module, and the subscriber library module in order to anticipate likely supplemental orders. The sale system above may further comprise a customer interface module with which the sale control engine communicates offers for the supplemental sale of goods to likely customers. Additionally, the sale system above may further comprise the sale control engine developing a hierarchical list of likely customers for particular sale offers priorities by their probable likelihood of purchasing goods at particular sales terms. Additional claims may be made to a computer-implemented method enabling the above supplemental sale system. Additionally, claims may be made to a process for operating such sale system, as shown and described in FIGS. 4-9, and described above.

I claim:

1. A supplemental sales system comprising:
a sales control engine, an order receipt module, a production module, a distribution module, and a customer library module;
the sales control engine configured to receive data from two or more of the order receipt module, the production module, the distribution module, and the customer library module; and
the sales control engine configured to identify the supplemental customer from the data, and identify a supplemental sales offer for the potential supplemental customer.

2. The supplemental sales system of claim 1, further comprising:
a customer interface module in data communication with the sales control engine, configured to receive a potential supplemental customer list of the potential supplemental customers; and
the customer interface module configured to communicate the supplemental sales offer to potential supplemental customers on the potential supplemental customer list.

3. The supplemental sales system of claim 2 where the supplemental sales offer is communicated to the potential supplemental customer by text message.

4. The supplemental sales system of claim 2 where the supplemental sales offer is for a limited time duration.

5. The supplemental sales system of claim 2 where the supplemental sales offer is for a specific good.

6. The supplemental sales system of claim 2, further comprising:
the sales control engine configured to identify a change in the supplemental sales offer based on updated data from at least one of the order receipt module, the production module, the distribution module, and the customer library module; and
the customer interface module communicates the change in the supplemental sales offer to the potential supplemental customer.
